(19) United States
(12) Patent Application Publication
(10) Pub. No.: US 2015/0063127 A1
(43) Pub. Date: Mar. 5, 2015

(54) TRANSMISSION APPARATUS AND TRANSMISSION METHOD

(71) Applicant: FUJITSU LIMITED, Kawasaki-shi (JP)

(72) Inventors: Yoshikazu Sabetto, Fukuoka (JP); Fusae Yamanouchi, Fukuoka (JP)

(73) Assignee: FUJITSU LIMITED, Kawasaki-shi (JP)

(21) Appl. No.: 14/338,618

(22) Filed: Jul. 23, 2014

(30) Foreign Application Priority Data
Aug. 28, 2013 (JP) 2013-177044

(51) Int. Cl. H04L 1/00

(52) U.S. Cl. CPC H04L 1/0002; H04L 1/0033
USPC 370/245

(57) ABSTRACT

There is provided a transmission apparatus which includes a transmission unit configured to transmit a control data to an opposite transmission apparatus at a transmission interval, a first determination unit configured to determine a communication quality of a network connected with the opposite transmission apparatus, and an adjustment unit configured to adjust the transmission interval, at which the control data is transmitted, to be longer than a reference transmission interval when the communication quality is equal to or greater than a predetermined value.

### CROSS-REFERENCE TO RELATED APPLICATION

This application is based upon and claims the benefit of priority from the prior Japanese Patent Application No. 2013-177044 filed on Aug. 28, 2013, the entire contents of which are incorporated herein by reference.

### FIELD

Exemplary embodiments of the present disclosure are related to a transmission apparatus and a transmission method.

### BACKGROUND

An IP (Internet Protocol) network such as, for example, Ethernet (registered trademark) accommodates a plurality of transmission apparatuses such as, for example, L2 switch, and incorporates a maintenance function such as checking of connectability between the transmission apparatuses or specifying of a fault location in the network. The Ethernet OAM (Operation Administration and Management) is known as a technology equipped with the maintenance function. The Ethernet OAM is standardized in, for example, the IEEE (802.1 ag) or ITU-T (Y1731).

The Ethernet OAM primarily intends to confirm the connectability between, for example, the transmission apparatuses and incorporates a CC (Continuity Check) function that regularly transmits and receives a CCM (Continuity Check Messages) frame to rapidly detect a fault. For example, an MEP (Maintenance End Point) which indicates a terminal end point of the CCM frame is set in a transmission apparatus and an opposite transmission apparatus. The transmission apparatus regularly transmits the CCM frame to the opposite transmission apparatus. Also, based on the reception result of the CCM frames, the opposite transmission apparatus detects a fault such as, for example, LOC (Loss of Connectivity) which is a fault between the transmission apparatus and the opposite transmission apparatus.

The transmission apparatus transmits, for example, a single CCM frame to the opposite transmission apparatus for every one interval. Further, a user changes the transmission interval of the CCM frame appropriately according to the network environment, and sets the changed transmission interval for each of the transmission apparatuses. Also, the opposite transmission apparatus receives a single CCM frame for every one interval. FIG. 12 is an explanatory view illustrating the state of the CCM frame.

For example, as illustrated in (A) of FIG. 12, when a CCM frame is received from a transmission apparatus, an opposite transmission apparatus determines that the communication state is in a normal condition. Further, as illustrated in (B) of FIG. 12, even when the CCM frame is not received from the transmission apparatus during transmission, the opposite transmission apparatus determines that the state is in the normal condition when a next CCM frame is received within 3.5 intervals (three and half intervals). Further, as illustrated in (C) of FIG. 12, when the next CCM frame is not received within 3.5 intervals, the opposite transmission apparatus determines that the state is in the LOC at the time when 3.5 intervals elapsed. As a result, the opposite transmission apparatus may recognize the occurrence of a fault between the opposite transmission apparatus and the transmission apparatuses based on the determination result regarding the LOC.

See, for example, Japanese Patent Application Laid-Open No. 2011-205301, Japanese Patent Application Laid-Open No. 2009-130474 and Japanese Patent Application Laid-Open No. 2007-251541.

### SUMMARY

Accordingly, it is an object in one aspect of the invention to provide a transmission apparatus including: a transmission unit configured to transmit a control data to an opposite transmission apparatus at a transmission interval; a first determination unit configured to determine a communication quality of a network connected with the opposite transmission apparatus; and an adjustment unit configured to adjust the transmission interval, at which the control data is transmitted, to be longer than a reference transmission interval when the communication quality is equal to or greater than a predetermined value.

The object and advantages of the invention will be realized and attained by means of the elements and combinations particularly pointed out in the claims.

It is to be understood that both the foregoing general descriptions and the following detailed descriptions are exemplary and explanatory and are not restrictive of the invention.

### BRIEF DESCRIPTION OF DRAWINGS

FIG. 1 is an explanatory view illustrating an example of a transmission system according to First Embodiment;

FIG. 2 is a block diagram illustrating an example of a transmission apparatus;

FIG. 3 is an explanatory view illustrating an example of a functional block diagram of a CPU of the transmission apparatus;

FIG. 4 is an explanatory view illustrating an example of a transmission interval of a CCM frame of the transmission system;

FIG. 5 is a flowchart illustrating an example of processing operations, which is related to a state notification process, of the CPU within the transmission apparatus;

FIG. 6 is a flowchart illustrating an example of processing operations of the CPU in the transmission apparatus, which is related to a first transmission interval adjustment process;

FIG. 7 is an explanatory view illustrating an occupation ratio of each CCM frame in each user data band;

FIG. 8 is an explanatory view illustrating an example of the transmission system according to Second Embodiment;

FIG. 9 is an explanatory view illustrating another example of the functional block diagram of a CPU of the transmission apparatus;

FIG. 10 is an explanatory view illustrating an example of a specific pattern;

FIG. 11 is a flowchart illustrating an example of processing operations of the CPU in the transmission apparatus, which is related to a second transmission interval adjustment process; and

FIG. 12 is an explanatory view illustrating a state of CCM frame.

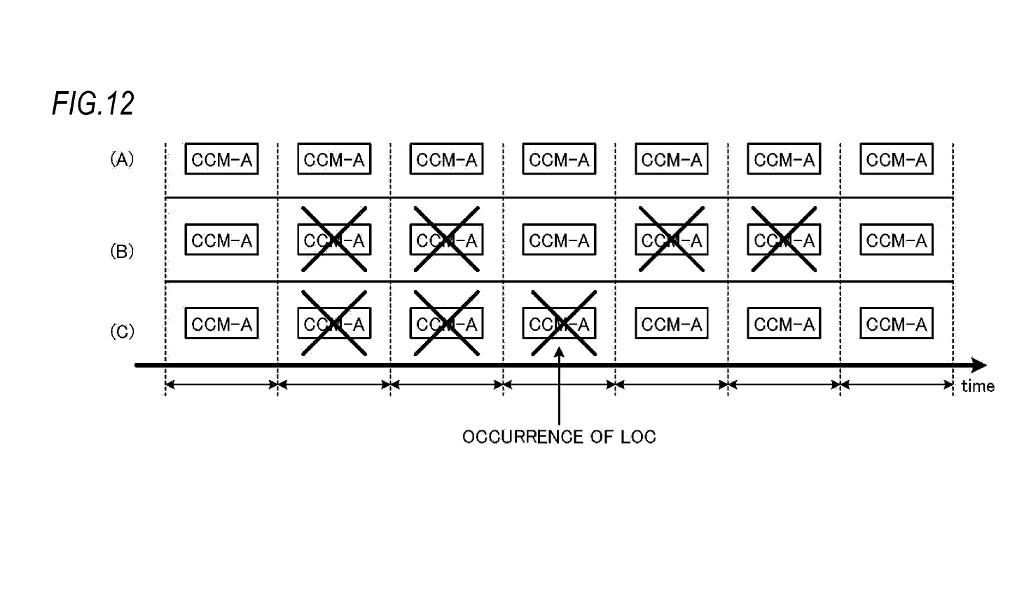

### DESCRIPTION OF EMBODIMENTS

The transmission interval of the CCM frame is always constant according to user setting irrespective of a line or communication state and thus, an amount of control data, such as a CCM frame, increases, for example, when the transmission interval is set to be shorter. As a result, the user data band used by the user is consumed as the amount of control data increases.

Further, for example, the user data band lent to the user is charged except for the control data, and thus, it is important for a communication service provider to reduce the control data to secure the user data band.

Hereinafter, referring to accompanying drawings, descriptions will be made in detail on an embodiment of a transmission apparatus and a transmission method that may suppress consumption of the user data band by the control data. Further, disclosed technologies are not limited to the present embodiment. Further, respective embodiments indicated below may be combined appropriately as long as they do not cause any contradiction.

### First Embodiment

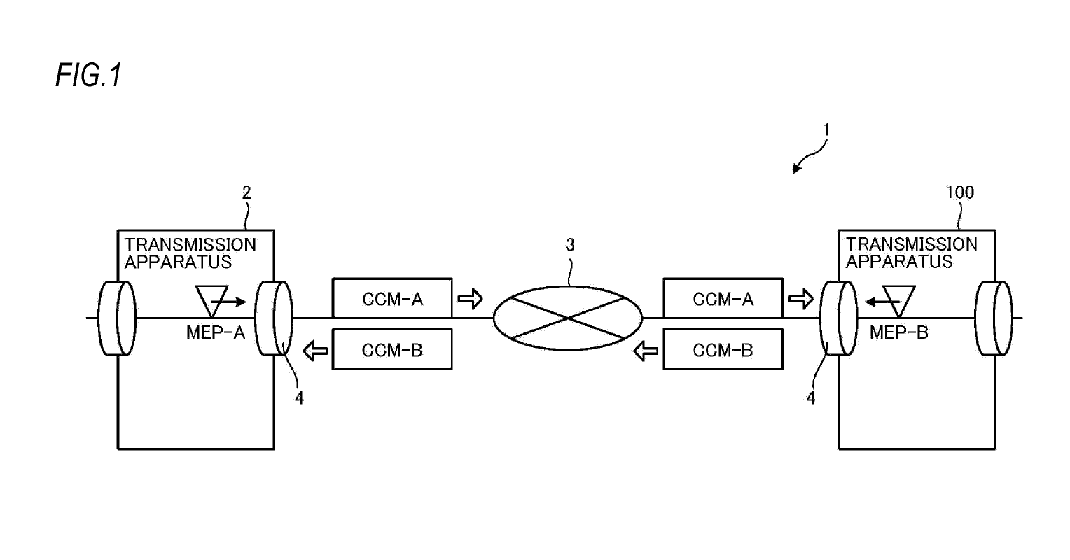

FIG. 1 is a block diagram illustrating an example of a transmission system according to First Embodiment. A transmission system 1 illustrated in FIG. 1 includes a transmission apparatus 2, an opposite transmission apparatus 100 and a network 3. An MEP which indicates a terminal end point of a CCM frame is set both in the transmission apparatus 2 and the opposite transmission apparatus 100. A MEP-A and a MEP-B are set in the transmission apparatus 2 and the opposite transmission apparatus 100, respectively. Further, for the convenience of explanation, it is assumed that the transmission apparatus 2 includes an adjustment function which automatically adjusts the transmission interval of the CCM frame while the opposite transmission apparatus 100 does not include the adjustment function.

The transmission apparatus 2 transmits a user data to the opposite transmission apparatus 100 via the network 3, and transmits a CCM frame (CCM-A) to the opposite transmission apparatus 100 at a set transmission interval via the network 3. Also, the opposite transmission apparatus 100 receives the user data from the transmission apparatus 2 via the network 3, and receives the CCM frame (CCM-A) from the transmission apparatus 2 via the network 3.

Further, the opposite transmission apparatus 100 transmits a user data to the transmission apparatus 2 via the network 3, and transmits a CCM frame (CCM-B) to the transmission apparatus 2 at a set transmission interval via the network 3. Also, the transmission apparatus 2 receives the user data from the opposite transmission apparatus 100 via the network 3, and receives the CCM frame (CCM-B) from the opposite transmission apparatus 100 via the network 3.

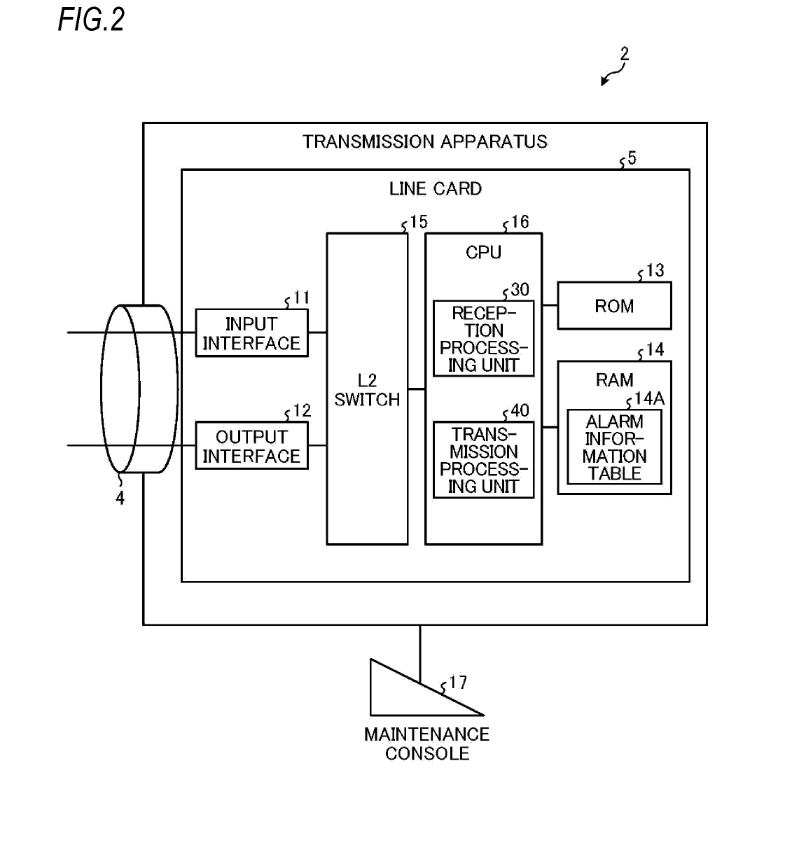

FIG. 2 is a block diagram illustrating an example of the transmission apparatus. The transmission apparatus 2 illustrated in FIG. 2 includes a line card 5. The line card 5 includes an input interface 11, an output interface 12, a ROM (Read Only Memory) 13, a RAM (Random Access Memory) 14, a L2 switch 15 and a CPU (Central Processing Unit) 16.

The input interface 11 is connected to the network 3 through a cable 4 to receive, for example, the CCM frame from other transmission apparatus within the transmission system 1. The output interface 12 is connected to the network 3 through the cable 4 to transmit, for example, the CCM frame to other transmission apparatus within the transmission system 1. The L2 switch 15 is connected with the input interface 11 and the output interface 12 to perform a connection process between channels performed by each of the input interface 11 and the output interface 12, and at the same time, performs various Layer-2 level processes. An alarm information table 14A storing various information such as alarm information is stored in the RAM 14. Further, the alarm information indicates a fault related to, for example, RDI (Remote Defect Indication) information added to the CCM frame. Further, various programs such as a transmission program is stored in the ROM 13.

The transmission apparatus 2 may appropriately change and set a frame rate, a transmission interval or an interval of the CCM frame depending on, for example, a line state, according to a setting operation from a maintenance console 17 by a maintenance operator.

The CPU16 controls the entire transmission apparatus 2 and reads out the transmission program stored in the ROM 13 to execute a CCM processing function. The CPU 16 includes a reception processing unit 30 and a transmission processing unit 40 as the CCM processing functionalities. The reception processing unit 30 receives the CCM frame from a opposite MEP, for example, a MEP of the opposite transmission apparatus 100. The transmission processing unit 40 transmits the CCM frame to the opposite MEP.

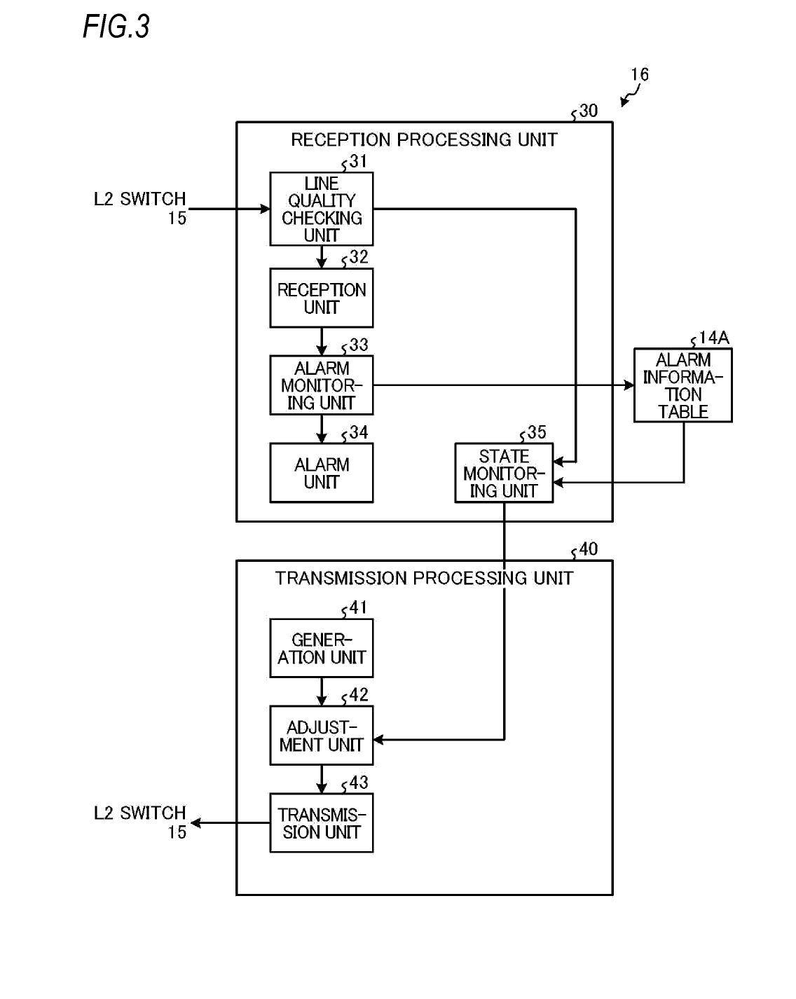

FIG. 3 is an explanatory view illustrating an example of a functional block diagram of the CPU 16 of the transmission apparatus. The reception processing unit 30 illustrated in FIG. 3 includes a line quality checking unit 31, a reception unit 32, an alarm monitoring unit 33, an alarm unit 34 and a state monitoring unit 35.

The line quality checking unit 31 monitors the degradation state of the line quality in the network 3 based on a frame reception rate or packet loss rate using the FEC (Forward Error Correction). Further, the line quality checking unit 31 determines whether a state of the line abnormality, which will be determined as a LOC before long, exists based on the monitoring result. Further, the line abnormality refers to the line state which is not determined as the LOC at current time but has a likelihood of being determined as the LOC before long. When the line abnormality exists, the line quality checking unit 31 notifies the state monitoring unit 35 of the line abnormality.

When the line abnormality does not exist, the reception unit 32 receives the CCM frame from the MEP of the opposite apparatus. When the line abnormality exists, the reception unit 32 discards the CCM frame received from the MEP of the opposite apparatus. Further, the alarm monitoring unit 33 determines whether the LOC exists or not based on the state of the CCM frame received from the MEP of the opposite apparatus. When one or more CCM frame may not be received from the MEP of the opposite apparatus within a predetermined interval, for example, 3.5 intervals (three and half intervals), the alarm monitoring unit 33 determines that the LOC exists. Further, when one or more CCM frame may be received from the MEP of the opposite apparatus within 3.5 intervals, the alarm monitoring unit 33 determines that the LOC does not exist, that is, a normal state. When it is determined that the LOC exists, the alarm monitoring unit 33 stores an alarm information including a determination result of the LOC in the alarm information table 14A.

When it is determined that the LOC exists, the alarm unit 34 sends the alarm information including the determination result of the LOC. The state monitoring unit 35 monitors the state of the network 3 based on the alarm information stored in the alarm information table 14A. The state monitoring unit 35 notifies the transmission processing unit 40 of the state of the network 3. Further, when the line abnormality from the line quality checking unit 31 is detected, the state monitoring unit 35 notifies the transmission processing unit 40 of the state of the network 3.

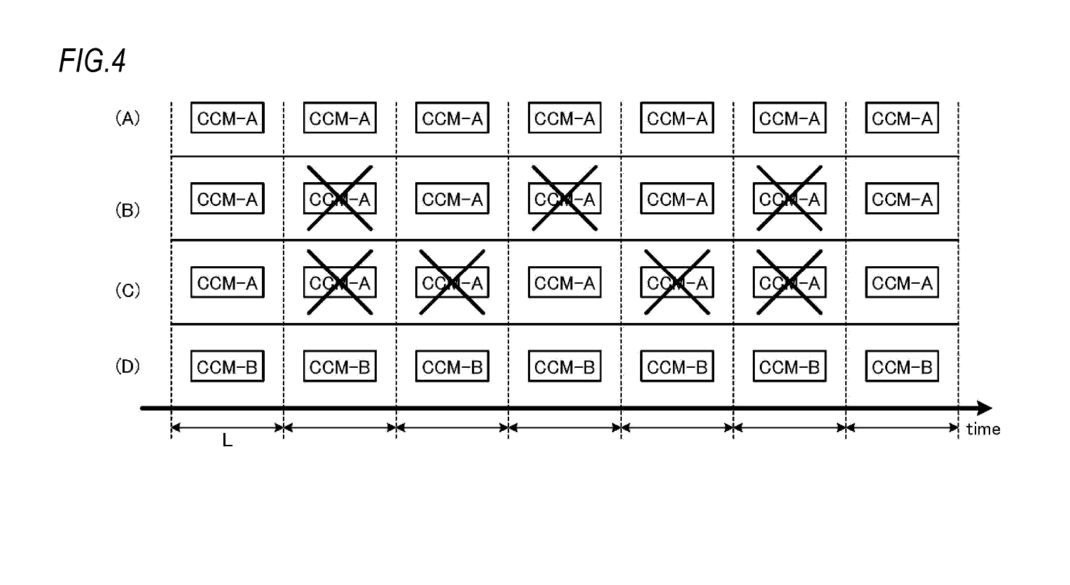

The transmission processing unit 40 includes a generation unit 41, an adjustment unit 42 and a transmission unit 43. The generation unit 41 creates a CCM frame. The adjustment unit 42 adjusts the transmission interval of the CCM frame based on the state of the network 3 which corresponds to the monitoring result of the state monitoring unit 35. Further, in the adjustment unit 42, the alarm monitoring unit 33 simply needs to transmit at least one CCM frame within 3.5 intervals and the transmission interval may be adjusted within a predetermined range. FIG. 4 is an explanatory view illustrating an example of a transmission interval of a CCM frame within the transmission system 1. The transmission interval of the CCM frame illustrated in (A) of FIG. 4 is a reference transmission interval of the transmission apparatus 2 at which one CCM frame is transmitted for every one interval of, for example, CCM-A→CCM-A→ . . . , and is defined as a transmission interval L. The transmission interval of the CCM frame illustrated in (B) of FIG. 4 is a transmission interval of the transmission apparatus 2 at which one CCM frame is transmitted for every two intervals of, for example, CCM-A→None→CCM-A→None→ . . . , and is defined as a first transmission interval L1. The transmission interval of the CCM frame illustrated in (C) of FIG. 4 is a transmission interval of the transmission apparatus 2 at which one CCM frame is transmitted for every three intervals of, for example, CCM-A→None→None→CCM-A→None→None→CCM-A→ . . . , and is defined as a second transmission interval L2. The transmission interval of the CCM frame illustrated in (D) of FIG. 4 is a reference transmission interval of the opposite transmission apparatus 100 at which one CCM frame is transmitted for every one interval of, for example, CCM-B→CCM-B→ . . . , and is defined as a transmission interval L.

The transmission apparatus 2 automatically sets a transmission interval to, for example, the reference transmission interval L, the first transmission interval L1 or the second transmission interval L2, according to the state of the network 3, for example, according to a communication quality level. In contrast, the opposite transmission apparatus 100 does not include the adjustment function and thus, the transmission interval, for example, the reference transmission interval L is set by the manipulation of the user irrespective of the communication quality of the network 3.

When a communication quality level X of the network 3 is less than the first threshold value X1 (X<X1), the adjustment unit 42 sets the reference transmission interval L as the transmission interval of the CCM frame. Further, the first threshold value X1 is equivalent to the communication quality level which indicates, for example, a case where the communication quality of the network 3 is high quality, an error rate is low and further, a non-arrived CCM frame does not exist. Further, when the line abnormality is detected by the line quality checking unit 31, the adjustment unit 42 sets the reference transmission interval L as the transmission interval of the CCM frame. When the communication quality level X of the network 3 is equal to or greater than the first threshold value X1 and less than the second threshold value X2 (X1≦X<X2), the adjustment unit 42 sets the first transmission interval L1 as the transmission interval of the CCM frame. Further, the second threshold value X2 is equivalent to a communication quality level having a higher quality than the communication quality level of the first threshold value X1. Further, when the communication quality level X of the network 3 is equal to or greater than the second threshold value X2 (X2≦X), the adjustment unit 42 sets the second transmission interval L2 as the transmission interval of the CCM frame. The transmission unit 43 transmits the CCM frame to the opposite MEP at the transmission interval set by the adjustment unit 42.

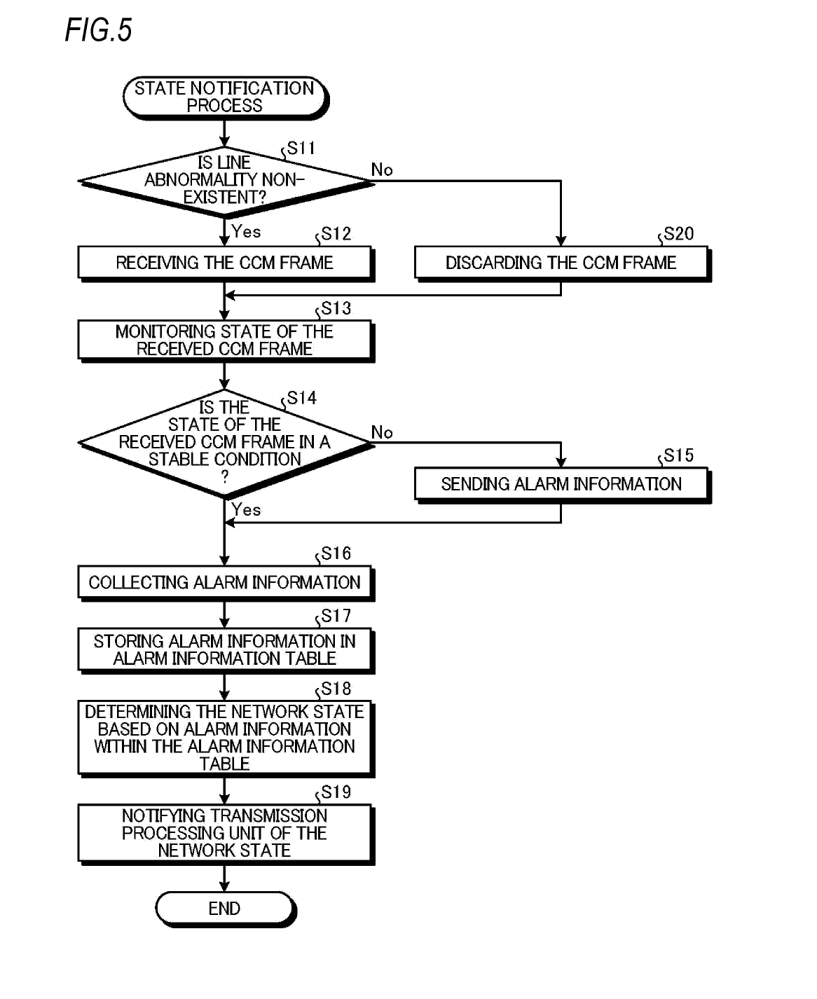

Next, operations of the transmission system 1 of First Embodiment will be described. FIG. 5 is a flowchart illustrating an example of processing operations of the CPU 16 within the transmission apparatus 2, which is related to a state notification process,. The state notification process illustrated in FIG. 5 is a process of determining the state of the network 3 and notifying the adjustment unit 42 of the transmission processing unit 40 of the determination result, which is performed in the reception processing unit 30.

In FIG. 5, the line quality checking unit 31 of the reception processing unit 30 checks the line quality and determines whether the line abnormality exists based on the check result (operation S11). Further, the line abnormality refers to the state of the network 3, for example, the state where signal error is detected and the LOC is determined as being existed. When it is determined that the line abnormality does not exist (“YES” at operation S11), the reception unit 32 of the reception processing unit 30 receives the CCM frame (operation S12).

The alarm monitoring unit 33 of the reception processing unit 30 monitors the state of the received CCM frame (operation S13) and determines whether the state of the CCM frame is in a stable condition based on the monitoring result (operation S14). Further, when the CCM frame is received within 3.5 intervals, the alarm monitoring unit 33 determines that the state of the CCM frame is in the stable condition. Further, when the CCM frame is not received within 3.5 intervals, the alarm monitoring unit 33 determines that the state of the CCM frame is not in the stable condition.

When it is determined that the state of the CCM frame is not in the stable condition (“NO” at operation S14), the alarm unit 34 of the reception processing unit 30 sends an alarm information which indicates a fault (operation S15). The alarm monitoring unit 33 collects the alarm information (operation S16) and stores the collected alarm information in the alarm information table 14A (operation S17).

The state monitoring unit 35 of the reception processing unit 30 determines a current state of the network 3 based on the alarm information within the alarm information table 14A (operation S18). The state monitoring unit 35 notifies the adjustment unit 42 within the transmission processing unit 40 of the communication quality level X which is the determination result of the state of the network 3 (operation S19), and ends the processing operations illustrated in FIG. 5.

When it is determined that the line abnormality exists (“NO” at operation S11), the reception unit 32 discards the CCM frame (operation S20), and proceeds to operation S13 to monitor the state of the CCM frame. Further, when it is determined that the line abnormality exists, the line quality checking unit 31 notifies the state monitoring unit 35 of the line abnormality. Also, when the line abnormality is detected from the line quality checking unit 31, the state monitoring unit 35 notifies the transmission processing unit 40 of the state of the network 3 that the line abnormality exists.

When it is determined that the state of the CCM frame is in a stable condition (“YES” at operation S14), the alarm monitoring unit 33 proceeds to operation S16 to collect the alarm information.

When it is determined that the state of the CCM frame is not in the stable condition, the reception processing unit 30 for the state notification process illustrated in FIG. 5 stores the alarm information of the LOC in the alarm information table 14A and determines the state of the network 3 based on the alarm information within the alarm information table 14A. The reception processing unit 30 notifies the transmission processing unit 40 of the determination result of the state of the network 3. As a result, the transmission processing unit 40 may recognize the communication quality level X which is the state of the network 3.

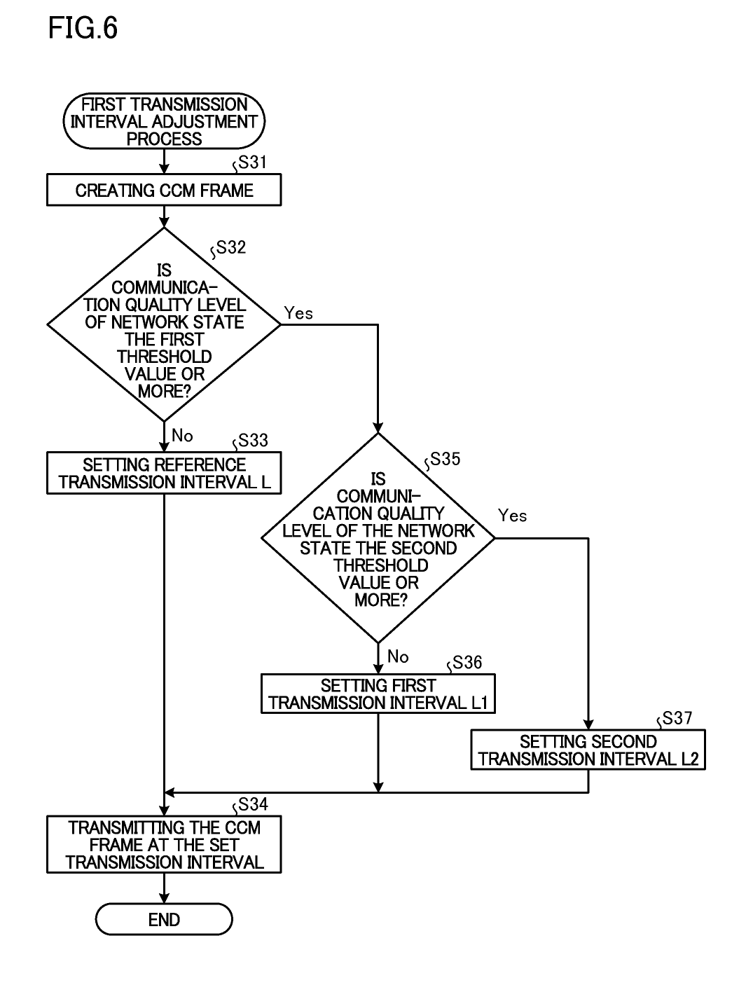

FIG. 6 is a flowchart illustrating an example of processing operations of the CPU 16 in the transmission apparatus 2, which is related to a first transmission interval adjustment process,. The first transmission interval adjustment process illustrated in FIG. 6 is a process of setting and changing the transmission interval at the time of transmitting the CCM frame, which is performed in the transmission processing unit 40. In FIG. 6, the generation unit 41 of the transmission processing unit 40 creates a CCM frame (operation S31). The adjustment unit 42 of the transmission processing unit 40 determines whether the communication quality level X of the network 3 is equal to or greater than a first threshold value X1 (operation S32).

When it is determined that the communication quality level X of the network 3 is less than the first threshold value X1 (“NO” at operation S32), the adjustment unit 42 sets the reference transmission interval L (operation S33). The transmission unit 43 of the transmission processing unit 40 transmits the CCM frame at the set transmission interval (operation S34), and ends the processing operation illustrated in FIG. 6.

When the communication quality level X is equal to or greater than the first threshold value X1 (“YES” at operation S32), the adjustment unit 42 determines whether the communication quality level X is equal to or greater than the second threshold value X2 (operation S35). When it is determined that the communication quality level X is less than the second threshold value X2 (“NO” at operation S35), the adjustment unit 42 sets the first transmission interval L1 as the transmission interval of CCM frame (operation S36), and proceeds to operation S34 to transmit the CCM frame at the set transmission interval.

When it is determined that the communication quality level X is equal to or greater than the second threshold value X2 (“YES” at operation S35), the adjustment unit 42 sets the second transmission interval L2 as the transmission interval of CCM frame (operation S37), and proceeds to operation S34 to transmit the CCM frame at the set transmission interval.

When it is determined that the communication quality level X is less than the first threshold value X1, the transmission processing unit 40 for the first transmission interval adjustment process illustrated in FIG. 6 sets the reference transmission interval L as the transmission interval for the CCM frame. For example, when the communication quality level X is reduced, the transmission processing unit 40 restores the transmission interval to the reference transmission interval to restore a normal CCM frame monitoring process.

When the communication quality level X is equal to or greater than the first threshold value X1 and less than the second threshold value X2, the transmission processing unit 40 sets the first transmission interval L1 as the transmission interval of CCM frame. As a result, the transmission interval becomes longer and the number of CCM frames becomes less dense compared to a case where the reference transmission interval L is set as the transmission interval and thus, the amount of CCM frames may be suppressed to ½ (one-half).

When the communication quality level X is equal to or greater than the second threshold value X2, the transmission processing unit 40 sets the second transmission interval L2 as the transmission interval of CCM frame. As a result, the transmission interval becomes longer and the number of CCM frames becomes less dense compared to a case where the reference transmission interval L is set as the transmission interval and thus, the amount of CCM frames may be suppressed to ⅓ (one-third).

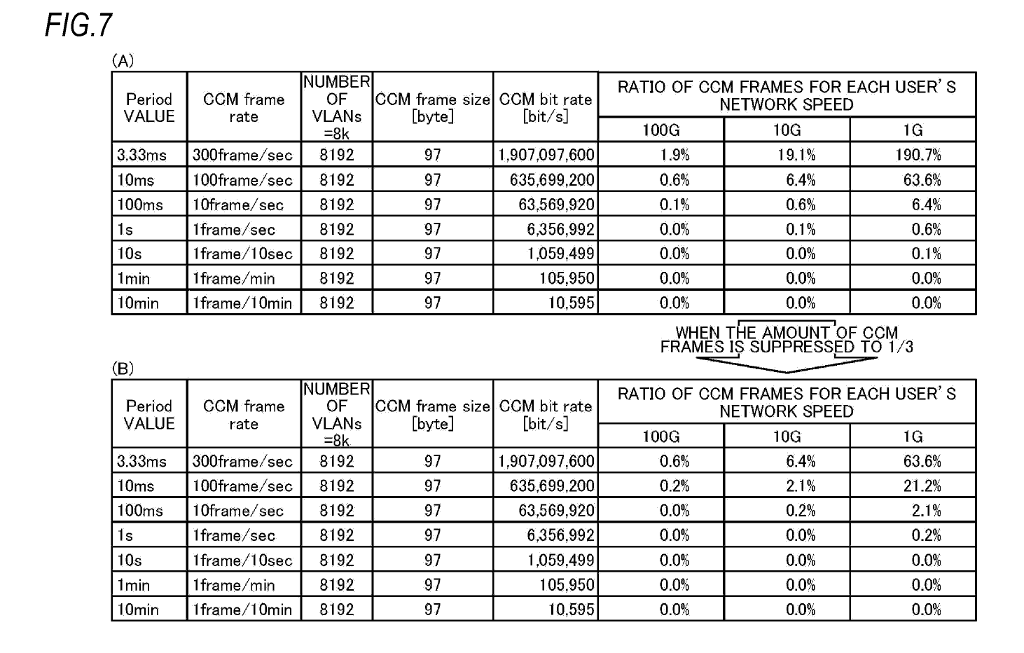

FIG. 7 is an explanatory view illustrating an occupation ratio of each CCM frame in each user data band. The table (A) of FIG. 7 illustrates a ratio of CCM frames in a case where the reference transmission interval L is set as a transmission interval and the table (B) of FIG. 7 illustrates a ratio of CCM frames in a case where the second transmission interval L2 is set as a transmission interval. Period value field indicates the length of a single interval. CCM frame rate field indicates the number of frames per second. The CCM frame size field indicates the size per CCM frame. The CCM bit rate field indicates the number of bits of the CCM frame per second. The ratio of the CCM frames for each user's network speed field indicates an occupation ratio of CCM frame in the user data band at, for example, the user's network speed of 100 Gbps, 10 Gbps and 1 Gbps. Hereinafter, the 100 Gbps, 10 Gbps and 1 Gbps may be denoted by 100G, 10G and 1G, respectively, by omitting the “bps”.

For example, a case is assumed where the reference transmission interval L is set as the transmission interval by noting that the Period value is 3.33 ms, the CCM frame rate is 300 frames/second, the number of VLANs is 8192 and the CCM frame size is 97 bytes. In this case, as illustrated in the table (A) of FIG. 7, the ratio of CCM frame to the user data band at 100G is 1.9%, the ratio of CCM frame to the user data band at 10G is 19.1%, and the ratio of CCM frame to the user data band at 1G is 190.7%. In contrast, when the second transmission interval L2 is set as the transmission interval, the CCM frame ratio is reduced from 1.9% to 0.6% at 100G, from 19.1% to 6.4% at 10G and from 190.7% to 63.6% at 1G. Further, for convenience of explanation, the CCM frame ratio is indicated as 190.7% for a case of 1G but actually, the CCM frame ratio is 100%.

For example, a case is assumed where the reference transmission interval L is set as the transmission interval by noting that the Period value is 10 ms, the CCM frame rate is 100 frames/second, the number of VLANs is 8192 and the CCM frame size is 97 bytes. In this case, as illustrated in the table (A) of FIG. 7, the CCM frame ratio is 0.6% at 100G, 6.4% at 10G and 63.6% at 1G. In contrast, when the second transmission interval L2 is set as the transmission interval, the CCM frame ratio is reduced from 0.6% to 0.2% at 100G, from 6.4% to 2.1% at 10G and from 63.6% to 21.2% at 1G.

That is, in the transmission apparatus 2, when the communication quality level X of the network 3 is equal to or greater than the first threshold value X1, it is possible to make the transmission interval of the CCM frame longer than the reference transmission interval L using the adjustment function to suppress the amount of the CCM frames for the user data band.

When the communication quality level X is less than the first threshold value X1, the transmission apparatus 2 of First Embodiment sets the reference transmission interval L as the transmission interval of the CCM frame. As a result, when the communication quality level X is reduced, the transmission apparatus 2 sets the transmission interval to be changed into the reference transmission interval L and thus, the normal CCM frame monitoring process may be restored.

When the communication quality level X is equal to or greater than the first threshold value X1 and less than the second threshold value X2, the transmission apparatus 2 sets the first transmission interval L1 as the transmission interval of CCM frame. As a result, the transmission apparatus 2 transmits the CCM frame to the opposite MEP at the first transmission interval L1. Therefore, the occupation ratio of CCM frame in the user data band may be reduced to ½ (one-half) as compared to a case where the reference transmission interval L is set as the transmission interval. Also, utilization efficiency of the user data band may be improved.

When the communication quality level X is equal to or greater than the second threshold value X2, the transmission apparatus 2 sets the second transmission interval L2 as the transmission interval of CCM frame. As a result, the transmission apparatus 2 transmits the CCM frame to the opposite MEP at the second transmission interval L2. Therefore, the occupation ratio of CCM frame in the user data band may be reduced to ⅓ (one-third) as compared to a case where the reference transmission interval L is set as the transmission interval. Also, utilization efficiency of the user data band may be improved.

In the transmission system 1 of First Embodiment, even when the opposite transmission apparatus 100 is not equipped with the adjustment function, the occupation ratio of CCM frame in the user data band at the time when the CCM frame is transmitted from the transmission apparatus 2 to the opposite transmission apparatus 100 may be suppressed.

Further, in First Embodiment, a transmission apparatus which is not equipped with the adjustment function is employed as the opposite transmission apparatus 100, but a transmission apparatus equipped with the adjustment function may be employed as well. Hereinafter, an embodiment in which the transmission apparatus equipped with the adjustment function is employed will be described.

### Second Embodiment

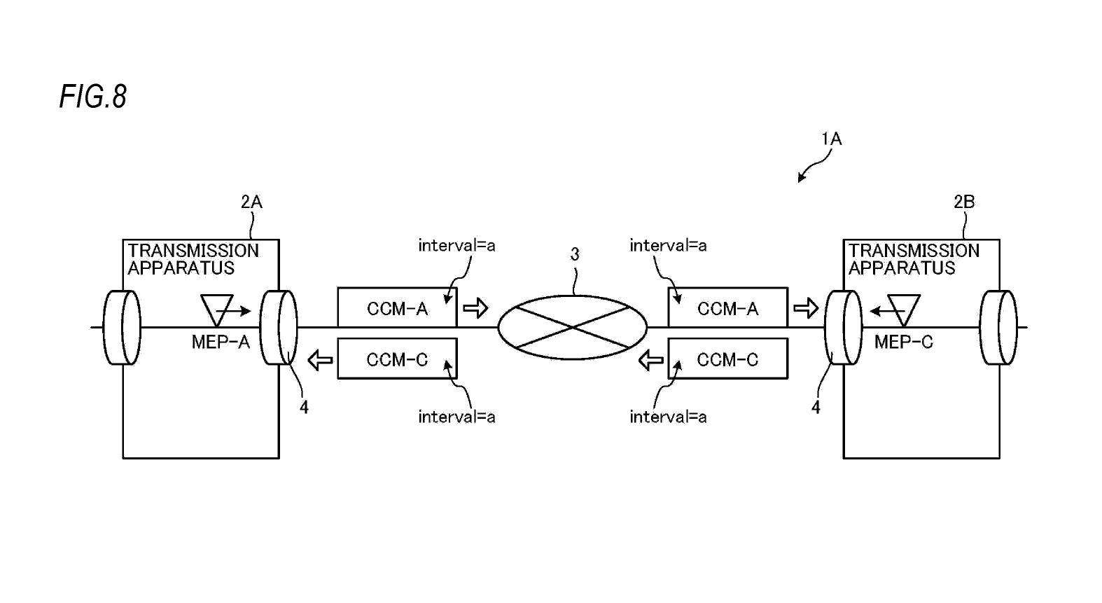

FIG. 8 is a block diagram illustrating an example of a transmission system 1A according to Second Embodiment. Further, components of the transmission system 1A that are the same as those of the transmission system 1 of First Embodiment are denoted by the same reference numerals, and descriptions of a redundant configuration and operation thereof will be omitted. The transmission system 1A illustrated in FIG. 8 includes a transmission apparatus 2A, an opposite transmission apparatus 2B and the network 3. MEPs indicating a terminal end point of the CCM frame are set in the transmission apparatus 2A and the opposite transmission apparatus 2B, respectively. An MEP-A and MEP-C are set in the transmission apparatus 2A and the opposite transmission apparatus 2B, respectively. Further, the transmission apparatus 2A and the opposite transmission apparatus 2B are equipped with the adjustment function which automatically adjusts the transmission interval of the CCM frame.

The transmission apparatus 2A transmits the user data to the opposite transmission apparatus 2B via the network 3 and regularly transmits the CCM frame (CCM-A) to the opposite transmission apparatus 2B via the network 3 at the set transmission interval. Further, the opposite transmission apparatus 2B receives the user data from the transmission apparatus 2A via the network 3 and the CCM frame (CCM-A) from the transmission apparatus 2A via the network 3.

Further, the opposite transmission apparatus 2B also transmits the user data to the transmission apparatus 2A via the network 3 and regularly transmits the CCM frame (CCM-C) to the transmission apparatus 2A via the network 3 at the set transmission interval. The transmission apparatus 2A receives the data from the opposite transmission apparatus 2B via the network 3 and the CCM frame (CCM-C) from the opposite transmission apparatus 2B via the network 3.

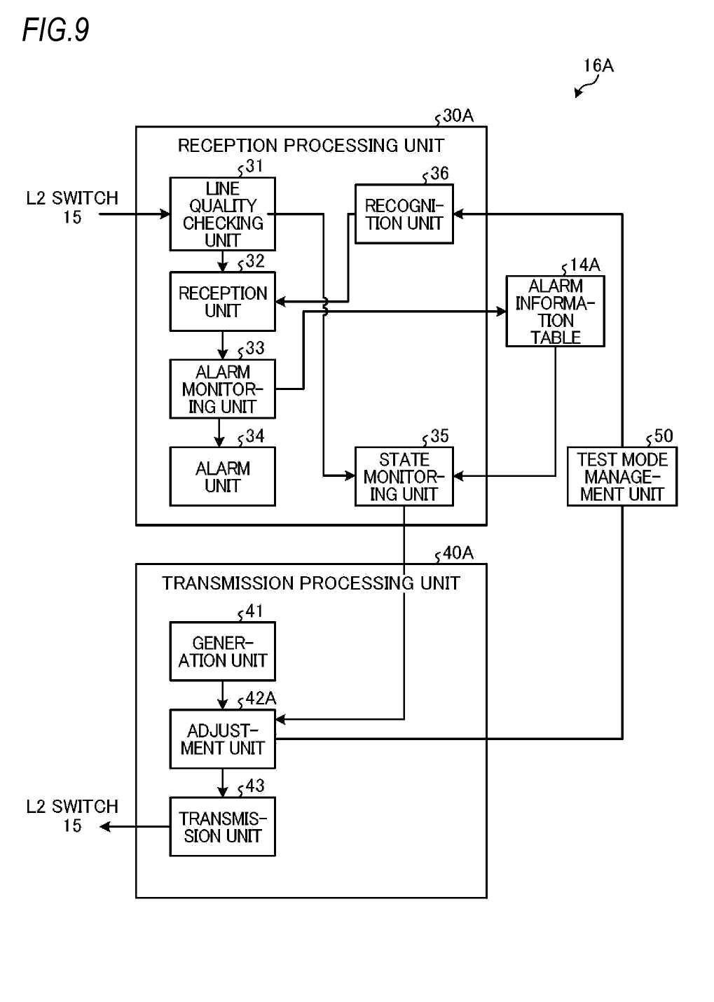

FIG. 9 is an explanatory view illustrating an example of a functional block of CPU 16A of the transmission apparatus 2A according to Second Embodiment. Further, since the configuration of the opposite transmission apparatus 2B is the same as that of the transmission apparatus 2A, the same components are denoted by the same reference numerals, and descriptions of the redundant configuration and operation will be omitted.

The CPU16A illustrated in FIG. 9 includes a reception processing unit 30A, a transmission processing unit 40A and a test mode management unit 50 as the CCM processing functionalities. The reception processing unit 30A further includes a recognition unit 36 in addition to the line quality checking unit 31, the reception unit 32, the alarm monitoring unit 33, the alarm unit 34 and the state monitoring unit 35. The recognition unit 36 recognizes a specific pattern, which notifies changing of transmission interval, from a group of CCM frames sent from the opposite MEP and specifies a transmission interval corresponding to the specific pattern. The alarm monitoring unit 33 determines whether the LOC, which refers to the state of the CCM frame, exists based on the transmission interval specified by the recognition unit 36.

The transmission processing unit 40A further includes an adjustment unit 42A in addition to the generation unit 41 and the transmission unit 43. When the communication quality level X of the network 3 is less than the first threshold value X1 (X<X1), the adjustment unit 42A sets the reference transmission interval L as the transmission interval of the CCM frame. In this case, the adjustment unit 42A transmits a third specific pattern to be described at the time of changing other transmission interval, which is being set, into the reference transmission interval L.

When the communication quality level X is equal to or greater than the first threshold value X1 and less than the second threshold value X2 (X1≦X<X2), the adjustment unit 42A sets the first transmission interval L1 as the transmission interval of CCM frame. In this case, the adjustment unit 42A transmits a first specific pattern to be described at the time of changing other transmission interval, which is being set, to the first transmission interval L1.

When the communication quality level X of the network 3 is equal to or greater than the second threshold value X2 (X2≦X), the adjustment unit 42A sets the second transmission interval L2 as the transmission interval of CCM frame. In this case, the adjustment unit 42A transmits a second specific pattern to be described later at the time of changing other transmission interval, which is being set, to the second transmission interval L2. The transmission unit 43 transmits the CCM frame to the opposite MEP at the transmission interval set by the adjustment unit 42A.

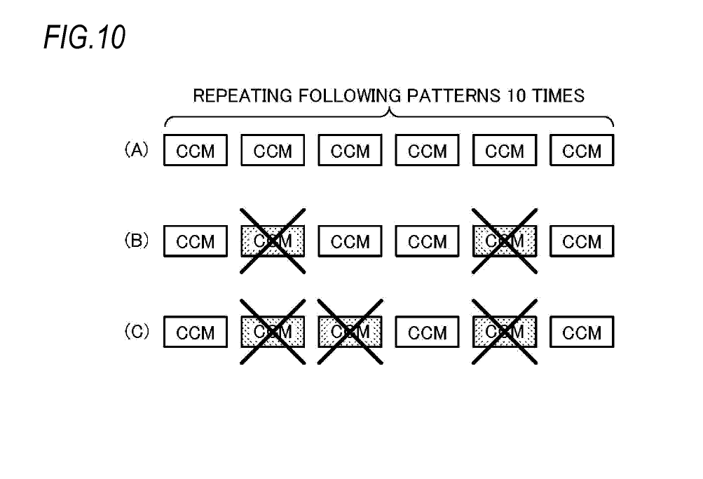

FIG. 10 is an explanatory view illustrating an example of a specific pattern. The third specific pattern illustrated in (A) of FIG. 10 is a CCM frame transmission pattern which notifies the opposite MEP that a transmission interval is changed from other transmission interval, which is being set, to the reference transmission interval L. The third specific pattern is a group of CCM frames that a pattern in which transmittal of one (1) CCM frame every one (1) interval is repeated six (6) times continuously, for example, CCM-A→CCM-A→CCM-A→CCM-A→CCM-A→CCM-A→ . . . , is repeated ten times continuously. The first specific pattern illustrated in (B) of FIG. 10 is a CCM frame transmission pattern which notifies the opposite MEP that a transmission interval is changed from other transmission interval, which is being set, to the first transmission interval L1. The first specific pattern is a group of CCM frames that a pattern of, for example, CCM→None→CCM→CCM→None→CCM→ . . . is repeated ten times continuously. The second specific pattern illustrated in (C) of FIG. 10 is a CCM frame transmission pattern which notifies the opposite MEP that a transmission interval is changed from other transmission interval, which is being set, to the second transmission interval L2. The second specific pattern is a group of CCM frames that a pattern of, for example, CCM→None→None→CCM→None→CCM→ . . . is repeated ten times continuously.

When a specific pattern transmitted from the opposite MEP is recognized, the recognition unit 36 of the transmission apparatus 2A specifies the transmission interval corresponding to the specific pattern. The transmission apparatus 2A may identify either a case where the transmission interval is made longer and thus the number of times that the CCM frame is transmitted is reduced even when the number of the received CCM frames is small, or a case where the CCM frame is discarded due to degradation of the communication quality.

When transmitting the specific pattern to the opposite MEP, the test mode management unit 50 shifts to a test mode different from a mode at the time of the normal CCM frame transmission. The test mode management unit 50 and another test mode management unit 50 within the transmission apparatus 2B for the opposite MEP notify an initiation of test mode with each other, thereby shifting to the test mode. The transmission unit 43 transmits the specific pattern to the opposite MEP during the test mode. Further, the test mode management unit 50 and another test mode management unit 50 within the transmission apparatus 2B for the opposite MEP notify a termination of test mode with each other, thereby terminating the test mode. Further, the CCM frame used in the normal CCM monitor processing or the user data are continuously transmitted between the transmission apparatus 2A and the transmission apparatus 2B even during the test mode.

Next, operations of the transmission system 1A of Second Embodiment will be described. When the specific pattern transmitted from the opposite MEP is recognized, the recognition unit 36 of the transmission apparatus 2A specifies the transmission interval of the opposite MEP corresponding to the specific pattern.

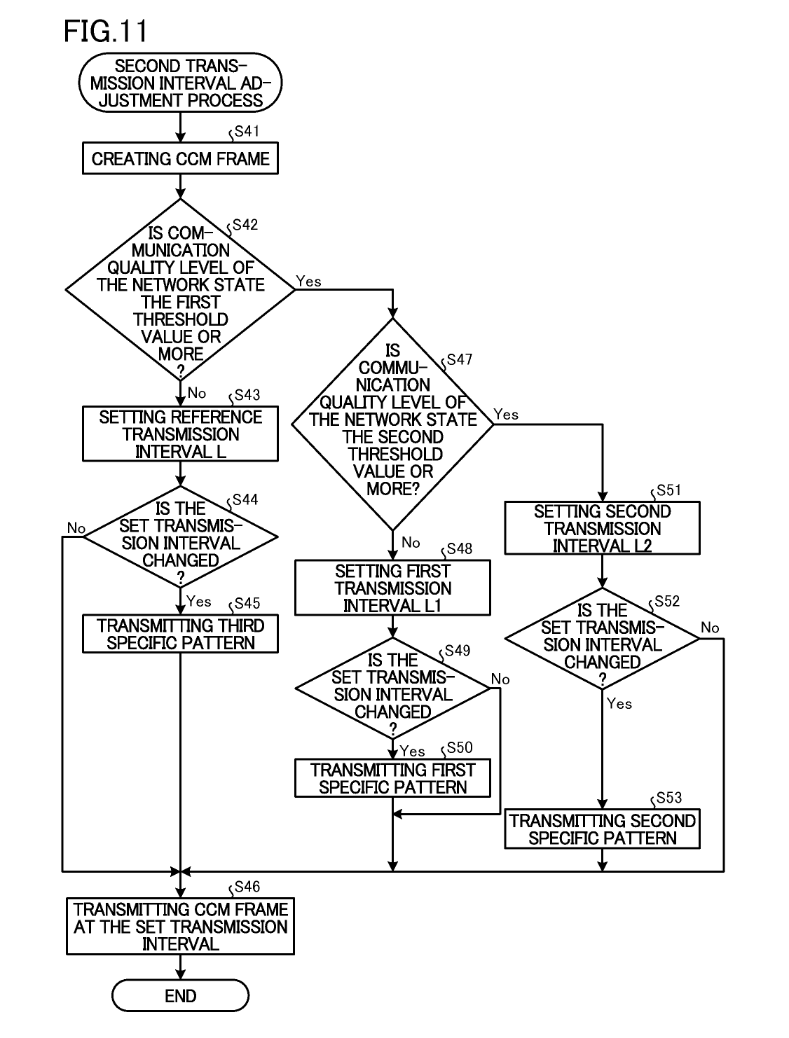

FIG. 11 is a flowchart illustrating an example of processing operations, which is related to a second transmission interval adjustment process, of the CPU 16A within the transmission apparatus 2A. The second transmission interval adjustment process illustrated in FIG. 11 is a process, which is performed in the transmission processing unit 40A, of notifying the opposite MEP of the transmission interval when setting the transmission interval at the time of transmitting the CCM frame according to the communication quality and changing the transmission interval. In FIG. 11, the generation unit 41 of the transmission processing unit 40A creates a CCM frame (operation S41). The adjustment unit 42A of the transmission processing unit 40A determines whether the communication quality level X is equal to or greater than the first threshold value X1 (operation S42).

When it is determined that the communication quality level X is less than the first threshold value X1 (“NO” at operation S42), the adjustment unit 42A sets the reference transmission interval L (operation S43) and determines whether the transmission interval set in the previous time is changed (operation S44). When it is determined that the transmission interval set in the previous time is changed (“YES” at operation S44), the adjustment unit 42A transmits the third specific pattern, which notifies changing of the set transmission interval into the reference transmission interval L, to the opposite MEP (operation S45). Further, the adjustment unit 42A is shifted to the test mode by the test mode management unit 50 and transmits the third specific pattern to the opposite MEP during the test mode to end the test mode. Further, when the third specific pattern transmitted from a counter-opposite MEP is detected, an opposite MEP may specify the reference transmission interval L which is set and changed by the counter-opposite MEP. Also, the transmission unit 43 transmits the CCM frame at the set transmission interval (operation S46) and ends the processing operation illustrated in FIG. 11.

When it is determined that the set transmission interval is not changed (“NO” at operation S44), the adjustment unit 42A proceeds to operation S46 to transmit the CCM frame at the set transmission interval.

When it is determined that the communication quality level X is equal to or greater than the first threshold value X1 (“YES” at operation S42), the adjustment unit 42A determines whether the communication quality level X is equal to or greater than the second threshold value X2 (operation S47). When it is determined that the communication quality level X is less than the second threshold value X2 (“NO” at operation S47), the adjustment unit 42A sets the first transmission interval L1 (operation S48) and determines whether the transmission interval set in the previous time is changed (operation S49).

When it is determined that the transmission interval set in the previous time is changed (“YES” at operation S49), the adjustment unit 42A transmits the first specific pattern, which notifies changing of the set transmission interval into the first transmission interval L1, to the opposite MEP through the transmission unit 43 (operation S50). Further, the adjustment unit 42A shifts to the test mode in the test mode management unit 50 and transmits the first specific pattern to the opposite MEP during the test mode, and ends the test mode. Further, when the first specific pattern transmitted from the counter-opposite MEP is detected, the opposite MEP may specify the first transmission interval L1 which is set and changed by the counter-opposite MEP. Also, the adjustment unit 42A proceeds to operation S46 to transmit the CCM frame at the set transmission interval. When it is determined that the transmission interval set in the previous time is not changed in the previous time (“NO” at operation S49), the adjustment unit 42A proceeds to operation S46 to transmit the CCM frame at the set transmission interval.

When it is determined that the communication quality level X is equal to or greater than the second threshold value X2 (“YES” at operation S47), the adjustment unit 42A sets the second transmission interval L2 (operation S51) and determines whether the transmission interval set in the previous time is changed (operation S52). When it is determined that the transmission interval set in the previous time is changed (“YES” at operation S52), the adjustment unit 42A transmits the second specific pattern, which notifies changing of the set transmission interval into the second transmission interval L2, to the opposite MEP (operation S53). Further, the adjustment unit 42A shifts to the test mode by the test mode management unit 50 and transmits the second specific pattern to the opposite MEP during the test mode, and ends the test mode. Further, when the second specific pattern from the counter-opposite MEP is detected, the opposite MEP may specify the second transmission interval L2 which is set and changed by the counter-opposite MEP. Also, the adjustment unit 42A proceeds to operation S46 to transmit the CCM frame at the set transmission interval. When it is determined that the transmission interval set in the previous time is not changed in the previous time (“NO” at operation S52), the adjustment unit 42A proceeds to operation S46 to transmit the CCM frame at the set transmission interval.

When the communication quality level X is less than the first threshold value X1, the transmission processing unit 40A for the second transmission interval adjustment process illustrated in FIG. 11 sets the reference transmission interval L as the transmission interval of the CCM frame. Further, when changing the transmission interval into the reference transmission interval L, the transmission processing unit 40A notifies the opposite MEP of the third specific pattern, which notifies changing of the reference transmission interval. As a result, the opposite MEP may specify the transmission interval L which is set and changed by the counter-opposite MEP.

When the communication quality level X is equal to or greater than the first threshold value X1 and less than the second threshold value X2, the transmission processing unit 40A sets the first transmission interval L1 as the transmission interval of the CCM frame. Further, when changing the transmission interval into the first transmission interval L1, the transmission processing unit 40A notifies the opposite MEP of the first specific pattern, which notifies changing of the first transmission interval. As a result, the opposite MEP may specify the first transmission interval L1 which is set and changed by the counter-opposite MEP.

When the communication quality level X is equal to or greater than the second threshold value X2, the transmission processing unit 40A sets the second transmission interval L2 as the transmission interval of the CCM frame. Further, when changing the transmission interval into the second transmission interval L2, the transmission processing unit 40A notifies the opposite MEP of the second specific pattern, which notifies changing of the second transmission interval X2. As a result, the opposite MEP may specify the second transmission interval L2 which is set and changed by the counter-opposite MEP.

The transmission apparatus 2A and the opposite transmission apparatus 2B are equipped with the adjustment function in the transmission system 1A of Second Embodiment. In the transmission system 1A, the transmission interval of the CCM frame from the transmission apparatus 2A to the opposite transmission apparatus 2B and the transmission interval of the CCM frame from the opposite transmission apparatus 2B to the transmission apparatus 2A are set to be longer than the reference transmission interval according to the communication quality level. As a result, the number of times that the CCM frame is transmitted from the transmission apparatus 2A to the opposite transmission apparatus 2B and the number of times that the CCM frame is transmitted from the opposite transmission apparatus 2B to the transmission apparatus 2A may be reduced to significantly suppress the occupation ratio of the CCM frame in the user data band compared to First Embodiment. Also, utilization efficiency of the user data band may be improved.

In the embodiments, a threshold value for determination the LOC is set as 3.5 intervals, but the threshold value is not limited to 3.5 intervals and may be appropriately changed.

In the embodiments, a transmission interval is set in three stages formed of the reference transmission interval L, the first transmission interval L1 and the second transmission interval L2 according to the communication quality level X, but the transmission interval is not limited to the three stages and may be appropriately changed.

In the embodiments, the transmission interval is set and changed stepwisely according to the communication quality level, but may also be set and changed continuously according to the communication quality level. Further, a communication quality level for which a communication quality indexes, such as for example, a communication quality, an error rate and a CCM frame reception rate is taken into account is adopted, but the communication quality level is not limited to these communication quality indexes and may be appropriately changed.

The transmission apparatus 2 of the embodiments may include a terminal end determination unit which manages the number of MEPs transmitting and receiving the CCM frame within the network 3 to determine whether the number of MEPs exceeds a predetermined number. When the number of MEPs exceeds a predetermined number in the terminal end determination unit, the adjustment unit 24 may set the transmission interval to be longer than the reference transmission interval. When a large number of MEPs exist within the network 3, the amount of CCM frames also increases to consume the user data band. However, when the number of MEPs exceeds the predetermined number, the transmission apparatus 2 sets the transmission interval to be longer than the reference transmission interval and thus, consumption of the user data band by the CCM frame may be suppressed.

Further, when the communication quality level X is equal to or greater than the first threshold value X1, the transmission apparatus 2 of the embodiments sets the transmission interval to be longer than the reference transmission interval L. However, the transmission apparatus 2 may determine whether the line abnormality exists continuously for a predetermined period and set the transmission interval to be longer than the reference transmission interval when the line abnormality does not exist continuously for a predetermined period.

The line quality checking unit 31 of the embodiments checks the state of the line quality based on, such as, the frame reception rate or the packet loss rate, but may use other index for the line quality to check the state of the line quality without being limited to the frame reception rate and the packet loss rate.

Further, the entirety of some of various processing functions performed by each device may be executed on a CPU (or a microcomputer such as, MPU (Micro Processing Unit) or MCU (Micro Controller Unit)). Further, the entirety of some of various processing functions may also be executed on a program analyzed and executed by the CPU (or a microcomputer such as, the MPU or MCU), or hardware configured by a wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission apparatus comprising:
a transmission unit configured to transmit a control data to an opposite transmission apparatus at a transmission interval;
a first determination unit configured to determine a communication quality of a network connected with the opposite transmission apparatus; and
an adjustment unit configured to adjust the transmission interval, at which the control data is transmitted, to be longer than a reference transmission interval when the communication quality is equal to or greater than a predetermined value.

2. The transmission apparatus according to claim 1, further comprising;
a second determination unit configured to determine whether the number of maintenance end points that transmit and receive the control data exceeds a predetermined number,
wherein the adjustment unit is configured to adjust the transmission interval to be longer than the reference transmission interval when the number of maintenance end points exceeds the predetermined number.

3. The transmission apparatus according to claim 1, wherein the adjustment unit is configured to adjust the transmission interval to make the transmission interval longer than the reference transmission interval based on information corresponding to the communication quality level, when the communication quality level is larger than the predetermined value.

4. A transmission method comprising:
transmitting a control data to an opposite transmission apparatus at a transmission interval;
determining a communication quality level of a network connected with the opposite transmission apparatus; and
adjusting the transmission interval, at which the control data is transmitted, to be longer than a reference transmission interval when the communication quality level is equal to or greater than a predetermined value.

5. A computer-readable recording medium storing a transmission program that causes a computer to execute a procedure, the procedure comprising:
transmitting a control data to an opposite transmission apparatus at a transmission interval;
determining a communication quality level of a network connected with the opposite transmission apparatus; and
adjusting the transmission interval, at which the control data is transmitted, to be longer than a reference transmission interval when the communication quality level is equal to or greater than a predetermined value.
